(19) United States
(12) Patent Application Publication
(10) Pub. No.: US 2022/0368132 A1
(43) Pub. Date: Nov. 17, 2022

(54) MICROGRID CONTROLLERS AND ASSOCIATED METHODOLOGIES

(71) Applicant: GO ELECTRIC, INC., Anderson, IN (US)

(72) Inventors: Robert Anthony SOVERNS, Anderson, IN (US); Alex Spencer CREVISTON, Anderson, IN (US)

(21) Appl. No.: 17/873,920

(22) Filed: Jul. 26, 2022

Related U.S. Application Data
(63) Continuation of application No. 16/050,367, filed on Jul. 31, 2018, now abandoned.
(60) Provisional application No. 62/540,141, filed on Aug. 2, 2017.

(51) Int. Cl. H02J 3/18; H02J 3/38

(52) U.S. Cl. CPC H02J 3/18; H02J 3/381; H02J 3/388; H02J 2300/20

(57) ABSTRACT

The present innovations control and improve operation of one or more microgrids optionally and/or intermittently coupled to an Electric Power System(s).

### CROSS REFERENCE AND PRIORITY CLAIM

This patent application claims priority to U.S. Provisional Application Ser. No. 62/540,141, “MICROGRID CONTROLLERS AND ASSOCIATED METHODOLOGIES,” filed Aug. 2, 2017, the disclosure of which being incorporated herein by reference in its entirety.

### FIELD

The presently disclosed innovations are directed to the field of controlling and improving operation of one or more microgrids optionally and/or intermittently coupled to an Electric Power System(s).

### BACKGROUND

Microgrids are discrete energy systems that include distributed energy sources and loads that may operate in parallel with, or independent from, a “main” power grid, also referred to in the industry as an Electric Power System (EPS). Such distributed energy sources are conventionally used to provide reliable energy security for commercial, industrial and government consumers, whether they be in an urban or rural environment, and dedicated to public, private, governmental and/or military electric power needs.

As the term conveys, microgrids are often implemented using the same technology used by conventional power grids, but on a smaller scale. Accordingly, microgrids are affected by conventional issues related to power generation and distribution, for example, balance and efficiency. However, microgrids have become more closely connected by proximity and design to alternative power generation sources such as renewable sources, like solar energy farms, geothermal energy production facilities, wind power turbine farms, hydroelectric facilities, industrial waste energy harvesting facilities and what have become known as Combined Heat and Power (CHP) systems).

Conventionally, such microgrids have been configured to provide the ability to both utilize local power generation sources, as above, while off-loading generated power in a prescribed manner on to larger, primary power grids in an effective manner so as to maintain proper operation of the primary power grid(s). Additionally, microgrids have been touted as providing the ability to perform autonomous self-healing, wherein, upon main power grid failure, one or more microgrids can operate independently of an EPS by decoupling itself from the primary power grid without affecting the primary grid's integrity and self supplying the microgrid's needs by isolating its generation nodes and power loads from a disturbance affecting the primary power grid. Thus, upon interruption of grid commutation beyond acceptable voltage and frequency limits, grid interactive inverters are required to cease energizing an area EPS, as specified in IEEE1547 and UL1741, which set out criteria and requirements for the interconnection of Distributed Energy Resources (DER), e.g., microgrids, into an EPS.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

The presently disclosed innovations are directed to controlling and improving operation of one or more microgrids.

In accordance with at least one embodiment, a controller embedded within the equipment coupling the at least one microgrid to an EPS is configured to control commutation so as to maintain operation of the at least one microgrid during an unexpected transition off of EPS power, i.e., transitioning from grid-interactive operation to grid independent operation. More specifically, embodiments may utilize the disclosed methodology to control commutation of a microgrid during an unexpected grid interactive to grid independent transition, thereby enabling a plurality of paralleled, grid interactive inverters to autonomously “ride through” the transition without interruption of power to loads of the microgrid.

In accordance with at least one embodiment, a controller embodied within the equipment coupling the at least one microgrid to an EPS is configured to control the power factor of the microgrid in grid independent operation using a plurality of paralleled inverters by operating one inverter in grid independent mode, thereby controlling voltage and frequency, and a second inverter in grid interactive mode, thereby controlling the power factor.

It should be understood that functionality and structure of the various embodiments may be combined in various manners to provide the functionality disclosed herein in various different implementations.

### BRIEF DESCRIPTION OF THE FIGURES

A more complete understanding of the disclosed embodiments and the utility thereof may be acquired by referring to the following description in consideration of the accompanying drawings, in which like reference numbers indicate like features, and wherein:

FIG. 1 illustrates an example of a microgrid that may be modified to incorporate the disclosed embodiments' structure and functionality in accordance with the disclosed embodiments.

FIG. 2 illustrates an example of a conventional, common Direct Current (DC) bus implemented microgrid and its constituent components.

FIG. 3 illustrates a microgrid and constituent components provided with control functionality implemented in accordance with at least a first exemplary embodiment.

FIG. 4 illustrates an example of operation of the first exemplary embodiment.

FIG. 5 illustrates a microgrid and constituent components provided with control functionality implemented in accordance with at least a first exemplary embodiment.

### DETAILED DESCRIPTION

For the purpose of promoting an understanding of the principles of the presently disclosed innovations, reference will now be made to the embodiments illustrated in the drawings, and specific language will be used to describe the same. It will, nevertheless, be understood that no limitation of the scope of the innovations is thereby intended; any alterations and further modifications of the described or illustrated embodiments and any further applications of the principles of the innovations as illustrated therein are contemplated as would normally occur to one skilled in the art to which the innovations relate.

One goal of microgrid technology is the ability to maintain power to loads, disconnect from the EPS in the event of an EPS failure, and reconnect to the EPS grid when power returns without disruption of power to the microgrid's load. Accordingly, as disclosed in U.S. Pat. No. 8,310,104, entitled “SUBSTANTIALLY BUMPLESS TRANSFER GRID SYNCHRONIZATION,” incorporated herein by reference in its entirety, microgrids may include an arbitrary number of DC and AC power sources to supply power to inverter subsystem that use a series of contactors and sensors to connect to an EPS grid. Thus, such an inverter subsystem may use power from a common DC bus as well as an arbitrary number of AC sources and associated components to control and coordinate power flow and storage on the common DC bus power inputs, or provide additional AC power back to one or more loads, or even the EPS grid. This may be performed under the direction of a site controller having four operational states: off, grid only, grid isolated and grid parallel.

In grid only mode, also known as grid interactive mode, all power requirements of loads may be addressed by the EPS grid. In grid independent (also known as isolated mode, or “islanding”), the inverter system supplies all power to the loads. Accordingly, once the EPS grid is restored, the inverter subsystem may then reconnect to the EPS grid in a current-limited, phase-synchronized bumpless fashion.

In grid parallel mode, an inverter subsystem of a microgrid is connected to the EPS grid. In grid parallel mode, an inverter subsystem is synchronized to the EPS grid using the commutating signal of the EPS, so the grid (in conjunction with the current limit of inverter subsystem) effectively controls the frequency of inverter subsystem. In this way, the current limit of inverter subsystem maintains the current limit of power output to EPS grid. Also, the inverter subsystem provides power factor correction to EPS grid anytime it is connected to EPS grid in grid parallel mode.

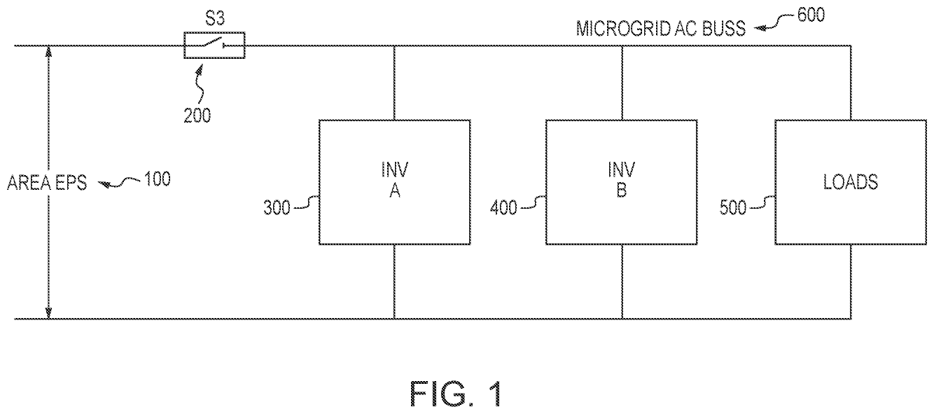

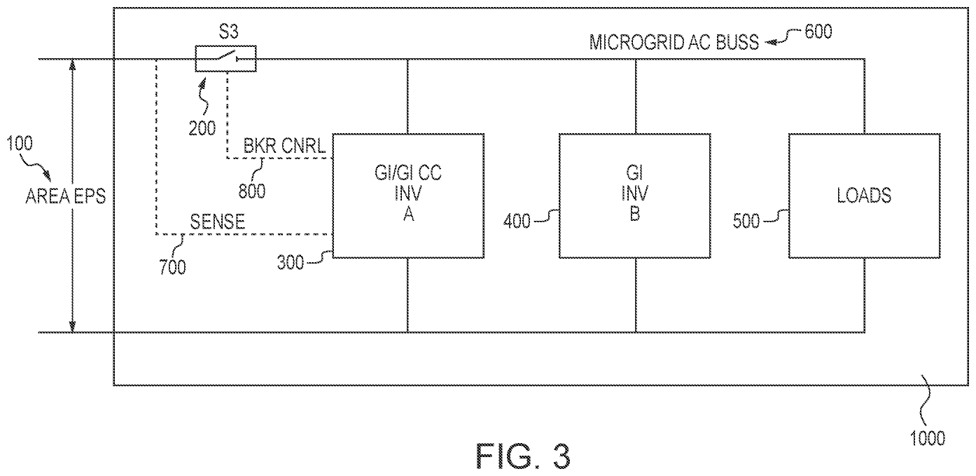

In accordance with at least a first embodiment, a controller embedded within the equipment coupling the at least one microgrid to an EPS is configured to control commutation so as to maintain operation of the at least one microgrid during an unexpected transition off of EPS power. Disclosed embodiments may be utilized in conjunction with the configuration illustrated broadly in FIG. 1 (but with more detail described in FIGS. 3-5.

As shown in FIG. 1, a microgrid AC bus 600 couples an area EPS 100 to one or more loads 500. In order to conform with requirements related to IEEE1547 and UL1741, grid interactive inverters A and B 300, 400 are provided and configured to cease energizing the area EPS 100. Additionally, breaker switch S3 200 is used to couple/decouple the microgrid bus 600 and its associated components with the area EPS 100.

Operation of the grid interactive inverters 300, 400, which are typically utilized by renewable energy resources, cease energizing the area EPS 100 in response to an interruption of grid commutation beyond acceptable voltage and frequency limits. This prevents renewable energy resources from being included in any energy resiliency system.

However, using conventional inverters, the commutation signal used by the microgrid is interrupted during transition from grid interactive (wherein a commutating signal from the EPS 100 is utilized to facilitate control of the components of the microgrid) to grid independent operation (wherein the microgrid components themselves must provide a commutating signal). When paralleled grid interactive inverters, or inverters operating in a grid interactive mode, no longer receive a commutating signal from an EPS, paralleled grid interactive inverters to cease output, thereby ceasing operation of the microgrid.

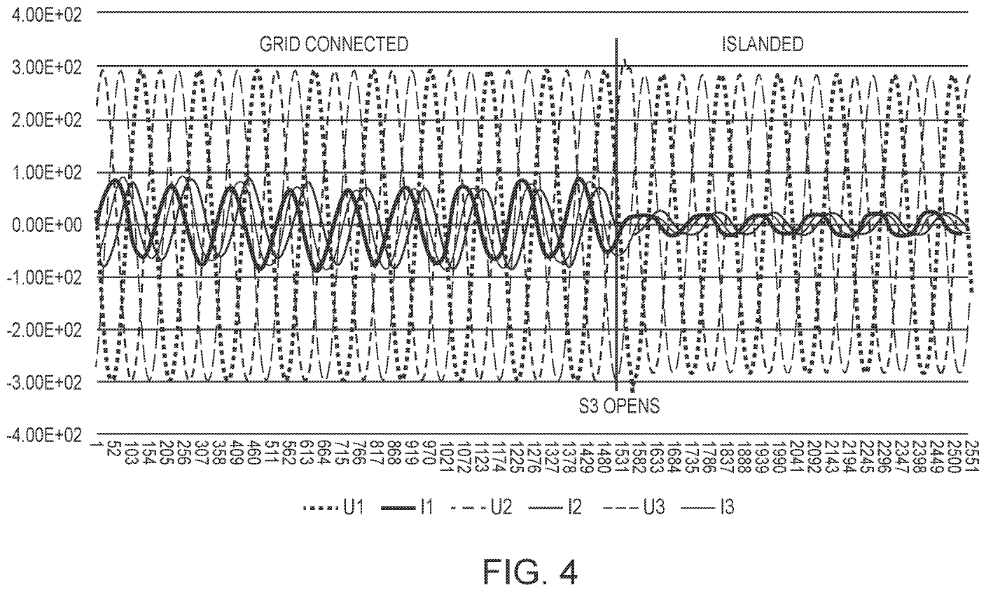

Presently disclosed embodiments, in particular the first disclosed embodiment, may utilize the herein disclosed methodology to control commutation of a microgrid during an unexpected grid interactive to grid independent transition, thereby enabling a plurality of paralleled, grid interactive inverters to autonomously operate during and after the transition without interruption of power to loads of the microgrid. In particular, at least a first disclosed embodiment provides controllers and control methodologies configured specifically to provide such control during an unexpected transition between a grid interactive state and a grid independent state. This control enables one or more paralleled grid interactive inverters to autonomously operate during such a transition without operation output interruption, as discussed below in relation to FIGS. 3-4.

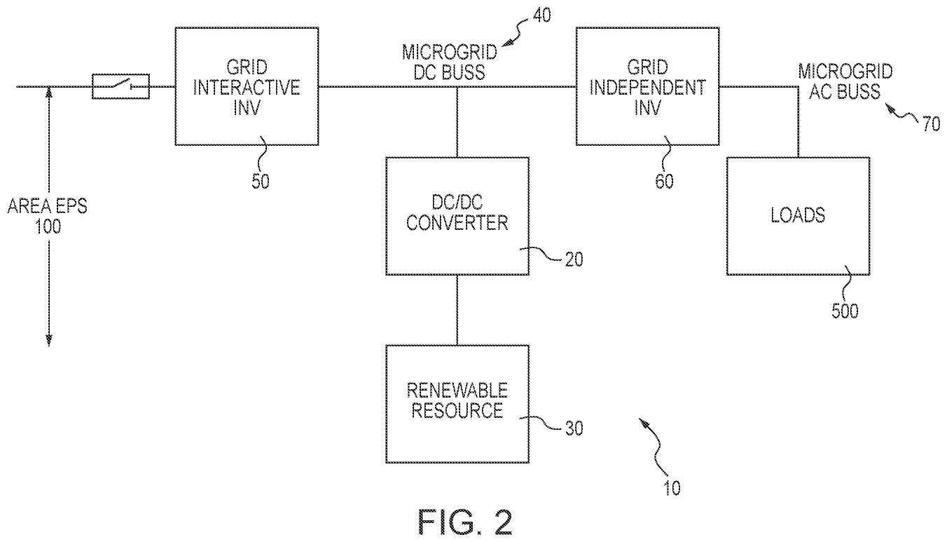

Disclosed embodiments provide improved technical utility over conventionally used common Direct Current (DC) bus implemented microgrids such as that illustrated in FIG. 2. As shown in that figure, although a common DC bus microgrid 10 can accomplish similar functionality to the presently disclosed embodiments, such an implementation also introduces several additional technical challenges that can only be addressed by multiple energy conversions by DC/DC converters 20 to convert energy from a renewable resource 30 to DC, which reduces overall system efficiency.

This reduction in efficiency significantly affects the functionality because the connection from the area EPS 100 to the loads 500 is not a direct connection and requires a double conversion (AC to DC and then DC to AC; not shown but included in the inverters 50, 60 respectively) configuration to provide AC power on the microgrid AC bus 70 to the loads 500. Each of these conversions reduces efficiency.

Additionally, various renewable resources (e.g., solar, wind, battery, etc.) have vastly different DC operating parameters. For example, solar panels operate most efficiently using Maximum Power Point Tracking (MPPT). This requires the DC bus to remain relatively constant. Batteries, however, have a DC voltage that varies with the state of charge. Accordingly, the incompatibility between the DC requirements between the two systems requires a DC to DC energy conversion by DC/DC converter 20. Again, each of these conversions reduce efficiency.

Moreover, the types of high power converters and high voltage DC components required for common DC bus microgrids are specialized products that are not commercially produced at scale. This greatly increases the manufacturing and installation cost of a common DC bus microgrid. Furthermore, high power DC/DC converters are not commercially available. Rather, high voltage, high power DC components are only commercially available in small markets.

To the contrary, high voltage, high power AC components are commercially available at scale and at much lower costs, which further increases the ability to technically implement the disclosed embodiments versus common DC bus microgrids.

In accordance with at least the first disclosed embodiment, a control strategy for controlling the commutation of a microgrid during the grid interactive to grid independent transition (and back) enables a plurality of paralleled grid interactive inverters to autonomously operate through the transition without interruption. Thus, as illustrated in FIG. 3, a microgrid system 1000 can be configured so that the common AC bus 600 of the microgrid disconnects from the Area EPS 100 via operation of breaker switch S3 200. The result of such a disconnection is that the microgrid system 1000 ceases to energize the area EPS 100 upon the interruption of grid commutation beyond acceptable voltage and frequency limits.

During this transition, one or more grid interactive inverters 300 maintain commutation on the common AC bus 600 in a bumpless transition. Such a transition requires that an operating voltage and frequency of the common AC bus 600 maintain within the ride though specified limits of the second inverter B 400 as explained herein.

The disruption on the common AC bus 600 is within acceptable operating voltage and frequency ride-through limits of the plurality of paralleled grid interactive inverters 400 because of the microgrid technology's ability to maintain commutation to the common AC bus during the disconnection from the EPS in the event of an EPS failure, and reconnect to the EPS grid when power returns.

The inverter 300 requires two controls to monitor and control the disconnection and reconnection events and accomplish the innovation. The Grid Sense 700 monitors the status of the EPS to determine when the grid commutation is within acceptable voltage and frequency limits. The BKR Control signal 800 is the method in which the inverter 300 controls both the disconnection from the EPS in the event of an EPS failure, and reconnection to the EPS grid when power returns.

FIG. 4 illustrates an embodiment of the voltage and current on the common AC bus 600 during the disconnection from the EPS in the event of an EPS failure. In the left section of FIG. 4 the inverter 300 is operating in grid interactive mode where the area EPS 100 is controlling the voltage and frequency. The inverter utilizes the Grid Sense 700 to monitors the status of the EPS to determine when the grid commutation is within acceptable voltage and frequency limits. At the midpoint of FIG. 4, the inverter senses the commutation is no longer within the acceptable limits and utilizes the BKR Control signal 800 to open the S3 breaker 200 and disconnect the Microgrid AC buss 600 from the EPS. At this point the inverter switches its internal commutation from grid interactive to grid independent mode. The inverter requires no interruption in its output signal during the transition. The second inverter B 400 and the Loads 500 would see no deviation in the Microgrid AC buss 600.

Indeed, one of the most frequently cited reasons for limiting integration of DERS, e.g., renewable energy resources such as Photo Voltaic (PV) and wind into an existing power grid is the unreliable and varying output of the renewable resource and the instability they cause in the EPS grid. This problem is exacerbated during an unexpected power outage or other voltage or frequency excursion because of the requirements to cease energizing an area EPS, as specified in IEEE1547 and UL1741. In accordance with at least the first disclosed embodiment, power from renewable energy sources within a microgrid may be utilized as an energy resiliency resource during unexpected power outages.

The Federal Energy Reliability Corporation which has the responsibility for maintaining energy resiliency standards for the area EPS. These standards currently require approximately 7% reserve capacity. Once the aggregate renewable energy resources contribution becomes greater than the required reserves, the unreliable and varying output of the renewable resources will prevent the EPS grid from maintaining energy resiliency and exacerbate the frequency and duration of power outages. This will require regulating additional reserve capacity to compensate for the loss in the renewable energy resources during an unexpected voltage or frequency excursions. Employing the disclosed embodiment, the power from renewable energy sources within a microgrid may be utilized as an energy resiliency resource during unexpected power outages and thus reduce the requirement for additional reserve capacity.

In accordance with at least a second exemplary embodiment for controlling and improving operation of a microgrid, a controller and methodologies are provided for actively controlling a power factor of a grid independent microgrid, or microgrid in grid independent (isolated, islanded) mode, using a plurality of paralleled inverters.

This is a novel control strategy for controlling the power factor of a grid independent microgrid using a plurality of paralleled inverters by operating one inverter in grid independent mode, controlling voltage and frequency and a second inverter in grid interactive mode, controlling the power factor.

As discussed briefly above, inverters have two at least two basic modes of operation: grid interactive and grid independent. As discussed above, grid interactive mode relies on an EPS grid for the commutation signal including both frequency and voltage. Thus, a grid interactive inverter simply regulates power and power factor. The second mode is grid independent, wherein the inverter regulates the frequency and voltage of the commutation signal on the microgrid AC bus, but cannot control power and power factor independently of frequency and voltage.

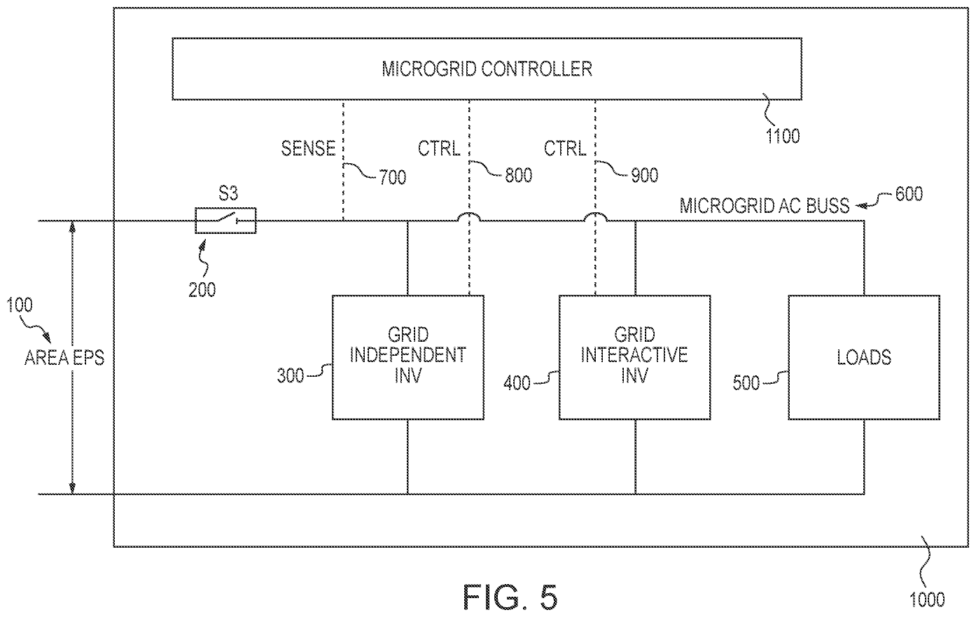

In accordance with at least the second disclosed exemplary embodiment, and as illustrated in FIG. 5, a microgrid system 1000 can be configured using a plurality of inverters 300, 400 so that the common microgrid AC bus 600 will operate while disconnected from an Area EPS 100 via breaker switch S3 200. This operation is enabled in such a way that the microgrid 1000 will operate in grid independent mode yet still components can control power factor.

As in the first embodiment, opening of the S3 breaker switch 200 disconnects the microgrid AC bus 600 from the Area EPS 100. Thereafter, microgrid controller 1100 may control/command the grid independent inverter 300 to operate in grid independent mode. As a result, commutation on the common microgrid AC bus 600 is maintained including control of both frequency and voltage. Simultaneously, or in conjunction (e.g., a serial manner), the microgrid controller 1100 controls/commands the second paralleled grid interactive inverter 400 to operate in grid interactive mode and regulate power and power factor on the common microgrid AC bus 600. That second paralleled inverter 400, which is a grid interactive inverter 400 relies on the grid independent inverter 300 for its commutation.

As a result, this configuration of microgrid controller 1100 in communication with and control of the inverters 300, 400 provides active power factor control, which is a vital consideration in a dynamically changing isolated microgrid as both distributed energy resources and loads are added and removed. This is because, renewable energy sources are uncontrollable DER and require dynamic load shedding schemes to properly implement in an isolated microgrid structure. Moreover, the power factor can change quickly and requires an active control circuit.

The inverter 300 may require two controls to monitor and control the disconnection and reconnection events and accomplish the innovation. The Grid Sense 700 may be configured to monitor the status of the EPS to determine when the grid commutation is within acceptable voltage and frequency limits. The BKR Control signal 800 is the mechanism by which the inverter 300 controls both the disconnection from the EPS in the event of an EPS failure, and reconnection to the EPS grid when power returns.

Moreover, in implementation, at least the second disclosed embodiment enables the inverter from a renewable energy resource to be utilized as an active power factor control device.

While operating in grid interactive mode, a single inverter may rely on the area EPS to control the voltage and frequency of the commutation. The grid interactive inverter can supply or draw both real and reactive power from the area EPS. When operating in grid independent mode, the single inverter cannot rely on the area EPS for its commutation signal. Thus, the grid independent inverter will control the microgrid voltage and frequency. However, at no time can a single inverter control both voltage/frequency and real/reactive power. Thus, in at least this second embodiment, a controller within the equipment coupling at least one microgrid to an EPS is configured to control the power factor of the microgrid in grid independent operation using a plurality of paralleled inverters by operating one inverter in grid independent mode, thereby controlling voltage and frequency, and a second inverter in grid interactive mode, thereby controlling the power factor.

Furthermore, in implementation, the grid interactive inverter may be implemented using conventional, off the shelf inverter technology. Thus, it should be appreciated that the microgrid controller 1100 in combination with the grid independent inverter 300 (positioned, coupled and configured as disclosed herein) provide the technical utility for at least the second disclosed exemplary embodiment.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A microgrid comprising:
a centralized controller configured to operate the microgrid for selective coupling with an Electric Power System (EPS);
a breaker switch arranged in communication with the centralized controller and operable according to the centralized controller between a connected position electrically connecting the microgrid with the EPS and a disconnected position electrically disconnecting the microgrid with the EPS;
a first inverter arranged in communication with the centralized controller, and configured to maintain electrical commutation on an AC bus; and
a second inverter coupled in parallel with the first inverter,
wherein the centralized controller is configured to determine whether EPS grid commutation is unacceptable, and responsive to determination that EPS grid communication is unacceptable, to control the breaker switch into the disconnected position, and to control conditions on the AC bus by simultaneous operation of the first and second inverters, including by issuing at least one command signal to force one of the first and second inverters to operate in a grid independent mode to regulate voltage and frequency on the AC bus to maintain electrical commutation on the AC bus, and to force the other of the first and second inverters to operate in a grid interactive mode to regulate power and power factor on the AC bus,
wherein the other of the first and second inverters forced into the grid interactive mode is configured to rely on the one of the first and second inverters in the grid independent mode for electrical commutation such that the microgrid operates as an isolated microgrid.

2. The microgrid of claim 1, wherein the first inverter is configured to maintain electrical commutation during a disconnection from the Electric Power System.

3. The microgrid of claim 1, wherein the first inverter includes two controls to monitor and control disconnection and reconnection events.

4. The microgrid of claim 3, wherein the first inverter further includes a grid sense that monitors the status of the Electric Power System to determine whether the grid commutation is within acceptable voltage and frequency limits.

5. The microgrid of claim 4, further comprising a BKR signal that controls disconnection from the Electric Power System performed in response to power failure, and reconnection to the Electric Power System in response to return of power.

6. The microgrid of claim 4, wherein the first inverter is configured to operate in a grid interactive mode and a grid independent mode.

7. The microgrid of claim 5, wherein the first inverter operates in a grid interactive mode in response to the breaker switch being closed and operates in a grid independent mode in response to the breaker switch being open.

8. The microgrid of claim 6, wherein the first inverter is configured to switch from grid interactive mode to grid independent mode in response to the commutation being no longer within acceptable voltage or frequency limits.

9. A microgrid for selective coupling with an Electric Power System, the microgrid comprising:
a centralized controller for operating the microgrid for selective coupling with the Electric Power System (EPS);
a breaker switch in communication with the controller and operable according to the controller between a connected position electrically connecting the microgrid with the EPS and a disconnected position electrically disconnecting the microgrid with the EPS;
an AC bus;
a first inverter arranged in communication with the AC bus and the controller, the first inverter configured to operate in grid independent mode; and
a second inverter configured to operate in grid interactive motive even while the first inverter operates in grid independent mode, the second inverter coupled with the AC bus in parallel with the first inverter,
wherein, the centralized controller is configured to determine occurrence of an unacceptable EPS grid electrical commutation, to responsively control the breaker switch into the disconnected position, and to responsively control conditions on the AC bus by operation of the first and second inverters, including by issuing at least one signal to the first inverter to force operation in grid independent mode to regulate voltage and frequency on the AC bus and to maintain electrical commutation on the AC bus, and to the second inverter to force operation in grid interactive mode based on the grid independent mode of the first inverter to regulate power and power factor on the AC bus, wherein the second inverter operating in grid interactive mode is configured to rely on the first inverter operating in grid independent mode for electrical commutation for operation of the microgrid as an isolated microgrid electrically disconnected with the EPS.

10.-12. (canceled)

13. The microgrid of claim 9, wherein the second inverter cooperates with the first inverter to form a commutated signal.

14. The microgrid of claim 9, wherein the first inverter includes two controls to monitor and control disconnection and reconnection events.

15. The microgrid of claim 14, wherein the first inverter further includes a grid sense that monitors the status of the Electric Power System to determine when the grid commutation is within acceptable voltage and frequency limits.

16. The microgrid of claim 15, further comprising a BKR signal that controls the disconnection from the Electric Power System in response to power failure, and the reconnection to the Electric Power System in response to return of power.

17. The microgrid of claim 9, further comprising a renewable energy source.

18. The microgrid of claim 17, wherein the renewable energy source includes an inverter configured to operate as an active power factor control device.

19. The microgrid of claim 9, wherein the second inverter is configured to supply or draw both real and reactive power from the Electric Power Source.

20. A method for operating a microgrid selectively coupled to an Electric Power System (EPS), comprising:
determining an unacceptable EPS grid commutation, and responsively disconnecting the EPS from the microgrid;
responsive to determining an unacceptable EPS grid commutation, issuing from a centralized controller at least one command signal to force operation of a first inverter into grid independent mode for regulating frequency and voltage of a commutation signal on an AC bus included in the microgrid;
responsive to determining an unacceptable EPS grid commutation, issuing from a centralized controller at least one command signal to force operation of a second inverter into grid interactive mode while the first inverter is in grid independent mode for regulating power and a power factor of the microgrid, wherein the second inverter is coupled with the AC bus in parallel with the first inverter, wherein regulating power and a power factor of the microgrid includes operating the second inverter in reliance for electrical commutation on the first inverter operating in grid independent mode to operate the microgrid as an isolated microgrid.

21.-27. (canceled)
